(19) United States
(12) Patent Application Publication
(10) Pub. No.: US 2010/0075109 A1
(43) Pub. Date: Mar. 25, 2010

(54) Microchip, Molding Die and Electroforming Master

(76) Inventor: Makoto Takagi, Aichi (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/447,362

(22) PCT Filed: Oct. 15, 2007
(86) PCT No.: PCT/JP2007/070067

§ 371 Date: Apr. 27, 2009

(30) Foreign Application Priority Data
Oct. 31, 2006 (JP) 2006-296389
Feb. 26, 2007 (JP) 2007-045321

(51) Int. Cl. B32B 3/30; B28B 11/10; C25D 1/10

(52) U.S. Cl. 428/167; 425/385; 204/281

(57) ABSTRACT

The present invention relates to a microchip, a die for forming the microchip, and an electroforming master for the die. A microchip is formed of a resin material and includes: a resin material; and a surface on which a channel groove with a width and depth both in a range of 1 to 1000 μm is formed. A bottom surface of the channel groove includes a projecting-and-depressed section with a height of 5% or lower of the depth of the channel groove.

### TECHNICAL FIELD

The present invention relates to a microchip, a molding die and an electroforming master, and in particular, relates to a microchip including a microscopic channel, a molding die for the aforesaid microchip and an electroforming master for the die to be a matrix of the molding die.

### BACKGROUND

In recent years, there is popularized an apparatus that is called a microchip or μTAS (Micro Total Analysis Systems), in which a channel and circuit are formed on a silicon substrate or a glass substrate through a microscopic processing technology for causing chemical reaction, separation, or analysis of liquid samples such as blood in a small space.

A microchip is generally made of glass, and various microscopic processing methods have been proposed (for example, see Patent Literature 1 and Patent Literature 2) However, glass is not suitable for mass production and production costs are extremely high, resulting in demands for development of an inexpensive and disposable microchip made of resin.

Further, in an element in which an inspection is carried out by making liquid samples run through a microscopic channel, like the microchip, it is necessary to adjust flow velocity of the samples so that the plurality of liquid samples may produce sufficient reactions in the channel. Therefore, there is employed a method applying surface treatment to give hydrophobic property to the channel surface of the microscopic channel, to adjust an amount of adsorption of samples, and thereby to obtain a predetermined flow velocity.

Patent Literature 1: Unexamined Japanese Patent Application Publication No. 2005-298312

Patent Literature 2: Unexamined Japanese Patent Application Publication No. 2006-26762

### DISCLOSURE OF INVENTION

### Technical Problem

However, there has been a problem that the surface treatment of this kind makes it difficult to obtain the predetermined flow velocity and required reaction products failed to be obtained, because plural liquid samples finish flowing through the microscopic channel too early before the plural liquid samples reacts with each other sufficiently.

In addition, when the surface treatment of this kind is employed and liquid samples flow thereon, a turbulent flow that interrupts the mainstream of the fluid undesirably causes on a bottom of the channel at the section where plural types of samples are mixed. It cannot cause desired reactions and cannot control a period of time for reactions of samples of plural types, therefore, it has been hardly generates compound with a desired particle size.

Further, in the method of preparing a microchip by gluing substrates after carrying out surface treatment on the microscopic channel, a microscopic channel which is free from leakage has been hardly formed, because it is difficult to employ a processing at high temperature such as thermal fusion which is commonly used.

The present invention has been achieved by taking the aforesaid points into consideration, and its object is to provide a microchip capable of controlling the flow velocity of a liquid sample that flows through a microscopic channel, a molding die, and an electroforming master.

### Solution to Problem

To achieve the above object, an invention described in claim 1 is a microchip that is formed of a resin material and the microchip comprises a surface on which a channel groove with a width and depth both in a range of 1 to 1000 μm is formed. A bottom surface of the channel groove comprises a projecting-and-depressed section with a height of 5% or lower of the depth of the channel groove.

According to the invention described in claim 1, the projecting-and-depressed section works as a resistance to liquid samples running through the channel and controls the velocity of the flow of the liquid samples. Further, it stirs liquid samples around the bottom surface of the channel. Therefore, the liquid samples are easily mixed, and it activates their reactions and secures period of time for reactions.

An invention described in claim 2 is a microchip of claim 1, in which the channel groove comprises a jointing point, and the projecting-and-depressed section is arranged in a vicinity of the jointing point and at a downstream position of the jointing point, and comprises two or more of depressed portions elongated along a extending direction of the channel groove.

An invention described in claim 3 is a microchip of Claim 1 or 2, in which the height of the projecting-and-depressed section is in a range of 0.01 to 10 μm.

An invention described in claim 4 is a die for forming a microchip which is formed of a resin material and comprises a surface on which a channel groove with a width and depth both in a range of 1 to 1000 μm is formed. The die comprises: a projecting potion corresponding to forming the channel groove, a top surface of the projecting portion comprising a die projecting-and-depressed section with a height of 5% or lower of a height of the projecting portion.

According to the invention described in claim 4, a microscopic-channel substrate including a projecting-and-depressed section with a height of 5% or lower of the depth of the channel groove, is manufactured.

An invention described in claim 5 is a die of claim 4, in which the height of the die projecting-and-depressed section is in a range of 0.01 to 10 μm.

According to the invention described in claim 5, a microscopic-channel substrate including a projecting-and-depressed section with a height in a range of 0.01 to 10 μm on the bottom surface, is manufactured.

An invention described in Claim 6 is a electroforming master for forming the die of Claim 4 or 5 through a electroforming, and the electroforming master comprises: a depressed portion corresponding to the projecting portion, in which a bottom surface of the depressed portion comprises a master projecting-and-depressed section with a height of 5% or lower of a depth of the depressed portion.

According to the invention of Claim 6, a molding die including a projecting-and-depressed section with a height of 5% or lower of a height of the channel groove on the top surface of the projecting portion corresponding the bottom surface of the microscopic-channel groove, is formed.

An invention described in Claim 7 is an electroforming master of Claim 6, in which wherein a height of the master projecting-and-depressed section is in a range of 0.01 to 10 μm.

According to the invention of Claim 7, a molding die including a projecting-and-depressed section with a height in a range of 0.01 to 10 μm on the top surface of the projecting portion corresponding the bottom surface of the microscopic-channel groove, is formed.

### ADVANTAGEOUS EFFECTS OF INVENTION

According to the invention described in Claim 1, aimed products can be obtained at a high yield in a reaction process in which plural liquid samples run through the microchip, because a microchip has a function to control the liquid samples to have a predetermined flow velocity of and a sufficient period of time for reactions of plural liquid samples can be secured.

According to the invention described in Claim 2, when mixing liquid samples by pouring a plurality of liquid samples in the microchip, occurrence of a turbulent flow that interrupts a mainstream of a fluid generated on the bottom of the groove for a channel of the microchip is controlled to become a laminar flow. Namely, mixture of liquid samples is controlled within a projecting-and-depressed section, and mixture is started when the liquid samples arrive at the portion where the projecting-and-depressed section is not formed. Therefore, in the reaction process in which plurality of liquid samples run through the microchip, the samples can easily be controlled to have the predetermined flow velocity, and the aimed reaction can be caused efficiently.

According to the invention described in Claim 3, aimed products can be obtained at a high yield in a reaction process in which plural liquid samples run through the microchip, because a microchip has a function to control the liquid samples to have the predetermined flow velocity and a sufficient period of time for reactions of plural liquid samples can be secured. Further, when mixing liquid samples by pouring a plurality of liquid samples in the microchip, occurrence of a turbulent flow that interrupts a mainstream of a fluid generated on a bottom of a groove for a channel of the microchip is controlled to become a laminar flow. Namely, mixture of liquid samples is controlled in a projecting-and-depressed section, and mixture is started when the liquid samples arrive at the portion where the projecting-and-depressed section is not formed. Therefore, in the reaction process in which plurality of liquid samples run through the microchip, the samples can easily be controlled to have the predetermined flow velocity, and the aimed reaction can be caused efficiently. In addition, in the projecting-and-depressed section of the microchip, the plurality of liquid samples are controlled to become a laminar flow and mixture of the plurality of liquid samples is started at a point where the projecting-and-depressed section is not formed. It enables the reaction time to be controlled and generate compounds with a desired particle size.

According to the inventions described in Claims 4 and 5, a microchip equipped with a function to restrain the flow velocity of liquid samples, can be prepared.

According to the inventions described in Claims 6 and 7, a die for forming a microchip equipped with a function to restrain the flow velocity of liquid samples, can be prepared.

### BRIEF DESCRIPTION OF DRAWINGS

FIG. 1 is a perspective view showing an electroforming master relating to the present embodiment.

FIG. 2 is an enlarged cross-sectional view showing a shape of a bottom surface of a microscopic channel formed on the electroforming master shown in FIG. 1.

FIG. 3 is a plan view showing a shape of a bottom surface of the microscopic channel shown in FIG. 2.

Each of FIGS. 4(a) to 4(d) is an example of a variation for a shape of a bottom surface of a microscopic channel relating to the present embodiment.

FIG. 5 is a plan view showing a cutting machine relating to the present embodiment.

FIG. 6 is an enlarged diagram for primary portions of the cutting machine shown in FIG. 5.

FIG. 7 is a diagram showing a process of a part of a manufacturing method for a microchip.

FIG. 8 is a diagram showing a process of a part of a manufacturing method for a microchip.

FIG. 9 is an exploded perspective view showing a molded microchip.

FIG. 10 is a cross-sectional view of the microchip that is shown in FIG. 8.

FIG. 11 is an exploded perspective view showing a microchip relating to the present embodiment.

FIG. 12 is an enlarged diagram for primary portions of the microchip shown in FIG. 1.

FIG. 13 is an enlarged cross-sectional view showing a shape of a bottom surface of a microscopic channel formed on the electroforming master shown in FIG. 1.

FIG. 14 is a perspective view showing an electroforming master relating to the present embodiment.

### REFERENCE SIGNS LIST

1, 70: Electroforming master
2, 92: Channel forming groove
3a, 3b, 93a, 93b: Groove for introduction path
4, 94: Groove for reaction path
5a, 5b, 95a, 95b: Groove for ejection path
6: Projecting-and-depressed section (Master projecting-and-depressed section)
7: Cutting machine
8: ease stand
9: Installation stand
10: Holding section
11: Tool spindle
12: Cutting tool
21, 61: Microscopic-channel substrate
22, 62: Microscopic channel
23a, 23b, 63a, 63b: Introduction path
24, 64: Reaction path
25a, 25b, 65a, 65b: Ejection path
26, 66: Projecting-and-depressed section
27a, 27b, 68a, 68b: Inlet
28a, 28b, 69a, 69b: Outlet
29, 67b: Cover
31, 70: Microchip
41: Master blank
42: Metallic deposit
50: Electroformed body
51: Molding die
52: Projecting portion

### BEST MODE FOR CARRYING OUT THE INVENTION

Referring to the drawings, there will be explained an embodiment of the invention, to which, however, the scope of the invention is not limited.

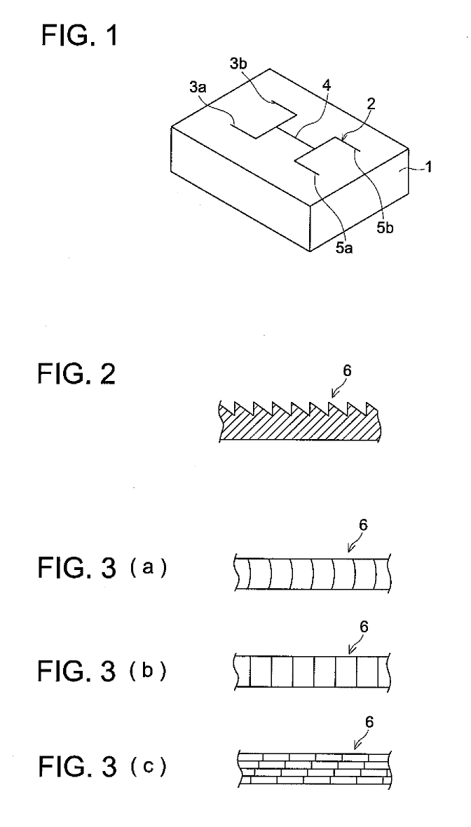

FIG. 1 is a perspective view showing an electroforming master relating to the present invention. As is shown in FIG. 1, channel forming groove 2 is formed on a surface of electroforming master 1. The channel forming groove 2 preferably has a width and depth of values within a range from 1 μm to 1000 μm, and more preferably has the values within a range from 10 μm to 100 μm.

The channel forming groove 2 has two grooves for introduction path 3a and 3b formed to be in parallel to each other with a constant interval. One end of each of the introduction paths 3a and 3b is bent in the direction to face each other to join together, to be connected to one end of groove for reaction path 4 having a required channel length. To the other end of groove for reaction path 4, a diverging point of two grooves for ejection paths 5a and 5b is connected, and respective grooves for ejection paths 5a and 5b are bent to be formed parallel to each other with a constant interval.

On the bottom surface of the groove for reaction path 4, there is formed projecting-and-depressed section 6 (master projecting-and-depressed section) that is composed of many grooves elongated perpendicular to the longitudinal direction of the groove for reaction path 4. Now, a shape of the bottom surface of the groove for reaction path 4 will be explained in the followings, referring to FIGS. 2 and 3. FIG. 2 is an enlarged cross-sectional view showing projecting-and-depressed section 6, and each of FIGS. 3(a), 3(b) and 3(c) is a plan view of a shape of a bottom surface shown in FIG. 2.

As is shown in FIG. 2 and FIG. 3(a), projecting-and-depressed section 6 is in a shape such that projecting-and-depressed portions each having a cross section in a triangular shape are continuously arranged. A top of a triangular shape of this projecting-and-depressed portions forms an arc shape whose central portion in the width direction of channel forming groove 2 is protruded in one direction, as shown in FIG. 3(a). The height of the projecting-and-depressed section 6 on the bottom surface is preferably 5% or lower of channel forming groove 2, and specifically, is preferably in the range from 0.01 μm to 10 μm. Further, this projecting-and-depressed section 6 is formed on the whole or a part of the groove for reaction path 4, and a location and a length of the projecting-and-depressed section 6 can be properly established depending on a type and the intended use of liquid samples.

In this case, it is possible to adjust an angle of each side wall of the triangular shape of the projecting-and-depressed section 6 to the bottom surface, and it is possible to provide larger resistance against the fluid by bringing an angle of a side wall facing the upstream side of the fluid to the bottom surface closer to 90°.

In the mean time, it is also possible that the tip of the triangular shape of the projecting-and-depressed section 6 forms a straight line elongated perpendicular to the running direction of the fluid, as shown in FIG. 3(b).

Further, as shown in FIG. 3(c), there can be formed a structure in which plural projecting-and-depressed sections 6 each having the shape shown in FIG. 3(b) is arranged in a row in the width direction of the channel forming groove 2.

The projecting-and-depressed section 6 is prepared through cutting processing.

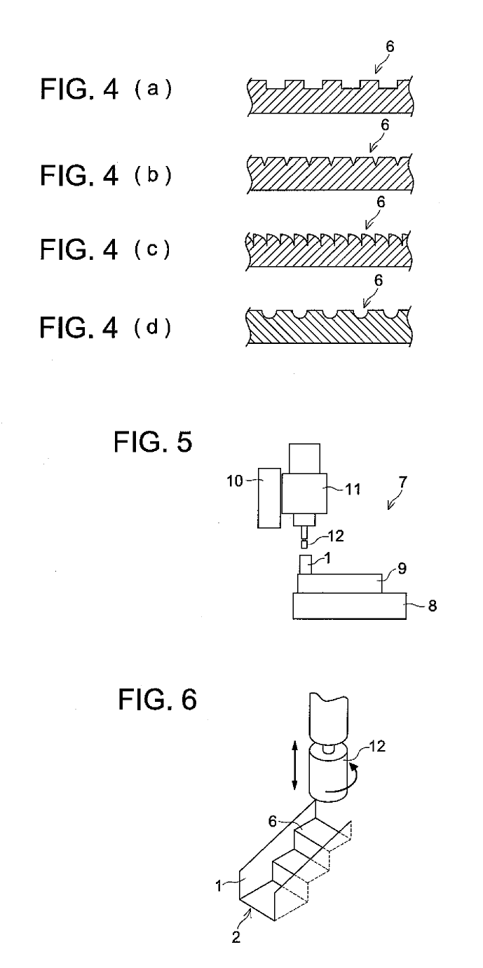

FIG. 5 is a side view showing cutting machine 7 used in the present embodiment.

As shown in FIG. 5, cutting machine 7 is equipped with base stand 8 which is movable in the horizontal direction (hereinafter, referred to as X direction). On the top surface of the base stand 8, there is installed installation stand 9 which is movable in the direction perpendicular to X direction on one plane. The installation stand 9 is provided for installing electroforming master 1 representing an object to be processed, on the top surface of the installation stand 9.

Further, tool spindle 11 supported by holding member 10 to be freely movable vertically in the vertical direction (hereinafter, referred to as Z direction) is arranged over the installation stand 9. Cutting tool 12 is attached under the tool spindle 11 for cutting the object to be processed through rotating actions of the tool spindle 11. The base stand 8, the installation stand 9, and the cutting tool 12 are arranged to be relatively movable so that the cutting tool 12 can cut the electroforming master 1 in the predetermined manner when the tool spindle 11 descends.

FIG. 6 is an enlarged diagram for showing how the cutting tool 12 cut the electroforming master 1.

In the present embodiment, the electroforming master 1 is set up to be tilted from the installation stand 9, and under this situation, the tool spindle 11 is lowered while it is rotating, to form a hole with cutting tool 12 at the position where groove for reaction path 4 is to be formed, as shown in FIG. 6. Next, the electroforming master 1 is moved in the direction that the groove for reaction path 4 is to be formed, by moving the electroforming master 1 in X direction or Y direction through the base stand 8 and the installation stand 9. Then, the tool spindle 11 is lowered again to form the groove for reaction path 4 with cutting tool 12. By repeating these operations, it is possible to form, on the bottom surface of groove for reaction path 4, the projecting-and-depressed section 6 composed of projecting-and-depressed portions each having triangular cross section whose top is formed to be in an arc shape.

Alternatively, employing another cutting tool 12, it is possible to form channel forming groove 2 in which projecting-and-depressed section 6 having specific shape shown in FIG. 2 and FIG. 3(b) is formed, by vertically moving this cutting tool 12 without rotating it and by moving electroforming master 1 in the X direction or Y direction.

Employing cutting tool 12 whose width is narrow, it is alternatively possible to form channel forming groove 2 in which projecting-and-depressed section 6 having specific shape shown in FIG. 2 and FIG. 3(c) is formed on the bottom surface of the channel forming groove 2, by repeating the aforesaid cutting processing.

Incidentally, a form of the projecting-and-depressed section 6 is not limited to that in the aforesaid embodiment, and forms shown in FIG. 4(a)-FIG. 4(d) can also be employed. FIG. 4(a)-FIG. 4(d) are sectional views showing variational examples of the projecting-and-depressed section 6.

The projecting-and-depressed section can be formed in a shape such that projecting-and-depressed portions each having rectangular cross section are continuously arranged as shown in FIG. 4(a), or in a shape such that notches each having an inverted-triangle cross section are formed at predetermined intervals on the projecting-and-depressed section as shown in FIG. 4(b). Alternatively, the projecting-and-depressed section can be formed in a shape such that depressed portions each being formed by a linear side wall and by a side wall that rises from a bottom section to be in an arc shape are continuously formed as shown in FIG. 4(c), or a shape such that depressed portions each being in a semicircle shape are formed at predetermined intervals as shown in FIG. 4(d).

Further, shapes shown in FIGS. 4(a)-4(d) can be formed by moving the cutting tool 12 vertically in a fixed pattern without rotating it, and by moving electroforming master 1 in X direction or in Y direction.

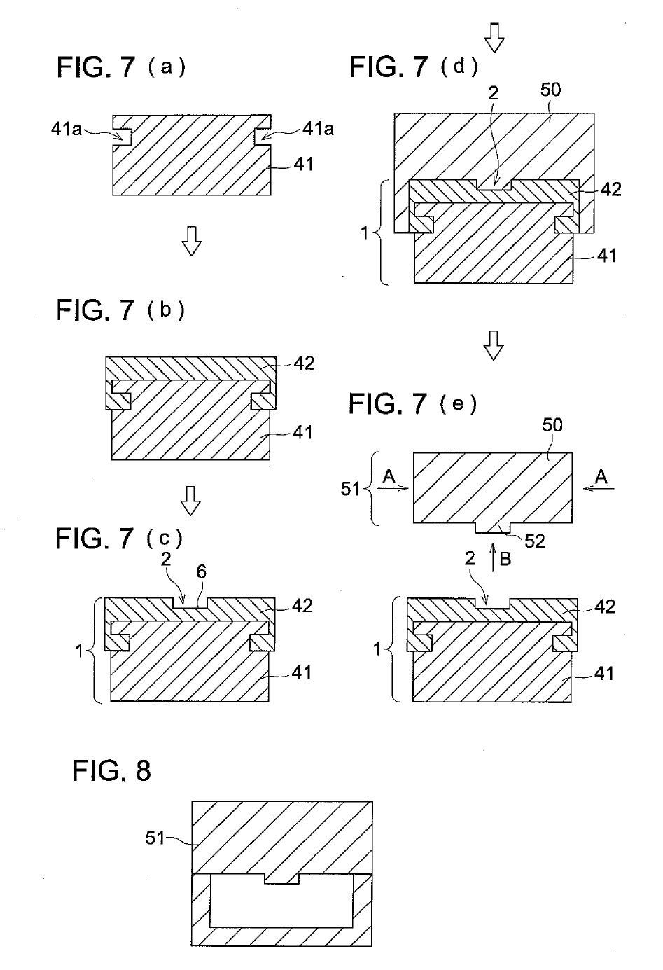

FIG. 7 is a diagram showing a process of a part of a manufacturing method for a microchip.

In an outline of a manufacturing method to manufacture microchip 31 from electroforming master 1, molding die 51 is manufactured from electroforming master 1, then, resins are molded by the molding die 51 to manufacture microscopic-channel substrate 21 having a surface on which microscopic channels 22 are formed, and the microscopic-channel substrate 21 and cover 29 are glued together. Each process of the aforesaid manufacturing method will be explained in detail as follows.

First, master blank 41 shown in FIG. 7(a) is prepared. After that, master blank 41 is plated with Ni—P or Cu to form metallic deposit 42, as shown in FIG. 7(b). The metallic deposit 42 is formed to embrace the master blank 41 around a portion from one side surface to the other side surface of the master blank 41 because of grooves 41a, so that the master blank 41 may hardly come off the metallic deposit 42.

After that, the top surface of the metallic deposit 42 is cut in the aforesaid manner as shown in FIG. 7(c), and thereby, channel forming groove 2 including the projecting-and-depressed section 6 which is in a shape shown in FIG. 2-FIG. 4 is formed on its bottom surface, thus, electroforming master 1 is completed. The electroforming master 1 is provided to be a matrix of a molding die for the microscopic channel substrate 21. In the meantime, an illustration of projecting-and-depressed section 6 on the bottom surface of the channel forming groove 2 will be omitted in FIG. 7.

Incidentally, the metallic deposit 42 does not always need to be on the electroforming master 1, and it is also possible, for example, to make up master blank 41 with homogenous materials such as aluminum alloy or oxygen-free copper so that it may serve as the electroforming master 1.

After that, as shown in FIG. 7(d), an oxide layer (not shown) is formed on the metallic deposit 42 of the electroforming master 1, then, the top portion of the oxide layer is electroformed to form thick electroformed body 50 so that it may cover the metallic deposit 42. The reason why the oxide layer is formed on the metallic deposit 42 before the electroforming is to simplify exfoliation of the electroformed body 50 from the electroforming master 1.

After that, finishing processing is conducted on a contour of the electroformed body 50 as shown in FIG. 7(e) under the condition where the electroformed body 50 is not exfoliated from the electroforming master 1, to remove a side portion of the electroformed body 50 until the side of the electroformed body 50 is aligned with the side of the electroforming master 1 (the metallic deposit 42).

After that, the electroformed body 50 on which the finishing processing has been conducted is exfoliated from the electroforming master 1 as shown by arrow B in FIG. 7(e), to remove the aforesaid oxide layer interposing between the lower surface (transfer surface) of the electroformed body 50 and the top surface of the metallic deposit 42 of the electroforming master 1. As a result, molding die 51 (upper die) equipped with projecting portion 52 which corresponds to channel forming groove 2 can be manufactured.

In the meantime, projecting-and-depressed section (die projecting-and-depressed section) with a height of 5% or lower of the height of the projecting portion 52 is formed on the top surface of the projecting portion 52, which is not illustrated, and the height of projecting-and-depressed section (die projecting-and-depressed section) is in the range from 0.01 to 10 μm.

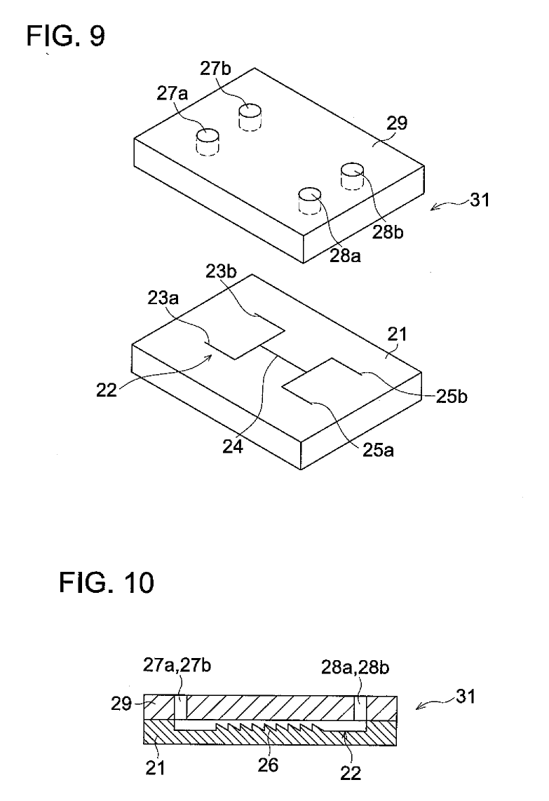

After that, as shown in FIG. 8, the molding die 51 and a corresponding lower die are set together to form a cavity to which resins such as thermoplastic resins are injected to be molded, thus, microscopic-channel substrate 21 shown in FIG. 9 is manufactured.

FIG. 9 is an exploded perspective view of microchip 31 employing the aforesaid microscopic-channel substrate 21, and FIG. 10 is a cross-sectional view of microchip 31.

As shown in FIG. 9 and FIG. 10, microscopic channel 22 (channel groove) of the microscopic-channel substrate 21 is composed of introduction paths 23a and 23b, reaction path 24, and ejection paths 25a and 25b. Cover 29 is joined, through thermal adhesion or through adhesive agents, to the microscopic-channel substrate 21 on the surface on which microscopic channel 22 is formed. At positions corresponding to end portions of introduction paths 23a and 23b of cover 29, there are formed inlets 27a and 27b, respectively. At positions corresponding to end portions of ejection paths of cover 29, there are formed outlets 28a and 28b, respectively.

After two types of liquid samples are poured through respective inlets 27a and 27b of cover 29, the liquid samples of two types which have passed through the introduction paths 23a and 23b join together on reaction path 24 to react with each other, and are ejected from respective outlets 28a and 28b through ejection paths 25a and 25b.

The microscopic-channel substrate 21 has, on a bottom surface of microscopic channel 22, projecting-and-depressed section 26 elongated perpendicular to the running direction of the fluid. A height of the microscopic channel 26 is 5% or lower of the depth of the microscopic channel 22, and it specifically is in the range from 0.01 to 10 μm. This projecting-and-depressed section 26 works as a resistance to liquid samples flowing through the microscopic channel 22, and this resistance can control the flow velocity of the fluid of liquid samples. Because it stirrers liquid samples in the vicinity of the bottom surface of microscopic channel 22, the liquid samples are easily mixed. As the result, the reaction is activated and sufficient reaction time is secured.

As a material for microchip 31, there are used resins which are excellent in heat resistance, chemical resistance, low fluorescence character, and in moldability, such as thermoplastic resins like polyethylene, polypropylene and polypentene or saturated cyclic polyolefin.

As liquid samples to be applied to microchip 31, there are favorably used biologic samples such as blood and organic compound such as a reagent.

In addition, the smaller groove width of microchip 31 exhibits the more improved mixture efficiency. However, the smaller groove width enlarges the risk for microscopic channel 22 to be closed. Therefore, the channel width and the groove depth of the microscopic channel 22 can be established properly depending on a type of reaction and on the intended use.

As explained above, electroforming master 1 shown in FIG. 1 makes it possible to prepare microchip 31 to which a function to control a flow velocity of liquid samples is added, whereby, objective products can be obtained at a high yield because sufficient reaction time can be secured in the reaction process in which plural liquid samples flow through the microchip 31.

It is further possible to easily form projecting-and-depressed section 26 that controls a flow velocity of the fluid, because microscopic channel 22 of the microscopic-channel substrate is formed by cutting the electroforming master 1 to form a groove for microscopic channels.

In addition, with respect to a form of the microscopic channel 22, it is not limited to the embodiment shown in FIG. 9, and it may be represented by a microscopic channel which includes plural reaction paths 24 which include different projecting-and-depressed sections 26 formed on the bottom surfaces, or a microscopic channel which includes three or more grooves for introduction paths which introduce liquid samples of three or more types.

Further, reaction path 24 has only to have a length of path needed for sufficient reaction and mixture for two liquid samples, and its shape may be of a meandering structure or a spiral structure, taking staying time of liquid samples into consideration.

In the aforesaid embodiments, the explanation has been given under the condition that a molding die is manufactured by using an electroforming master, but the invention can also be applied to ordinary molding die. In this case, a portion corresponding to the microscopic channel of the microscopic-channel substrate is not a groove, but it may be cut to become a projecting form.

Next, a microchip and an electroforming master which are other embodiments will be explained.

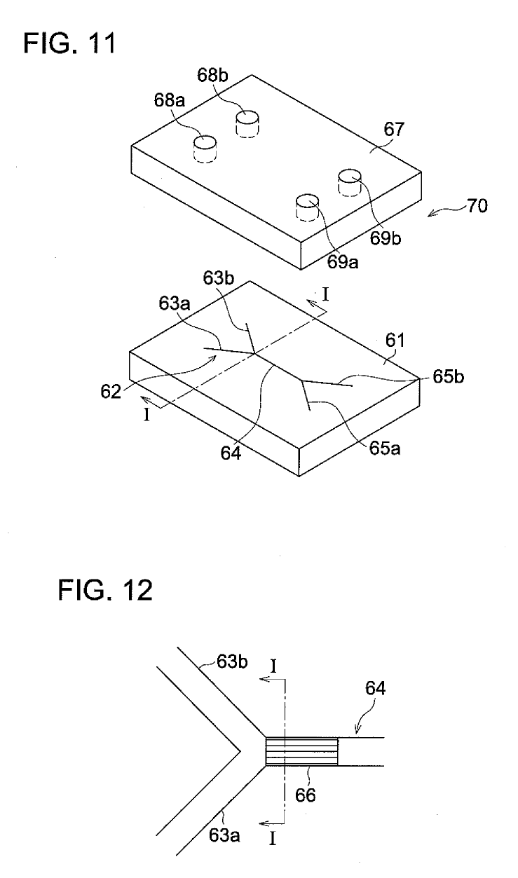

FIG. 11 is an exploded perspective view showing microchip 70 relating to the present invention.

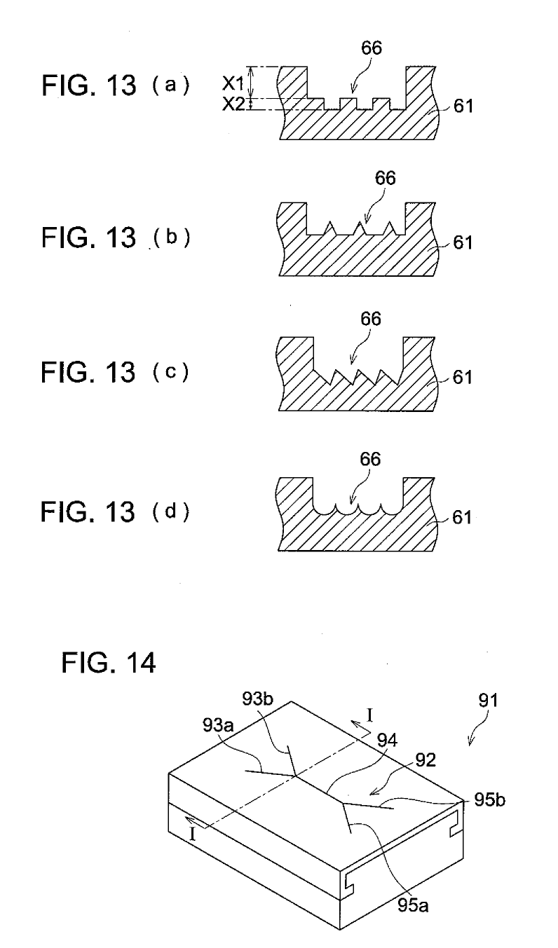

Microchip 70 includes microscopic channel substrate 61, as is shown in FIG. 11. On the microscopic-channel substrate 6, there is formed microscopic channel (channel groove) 62. The microscopic channel 62 preferably has a width and depth of values within a range of 1 μm-1000 μm, and more preferably has values within a range of 10 μm-100 μm. The depth of the microscopic channel 62 means a depth of the microscopic channel 62 that is formed first (X1 in FIG. 13(a)).

The microscopic channel 62 includes two introduction paths 63a and 63b which have the jointing point to meet each other at the downstream side, and are combined to be in a V-shape. One end of reaction path 64 having a necessary channel length is connected to the jointing point of the two introduction paths 63a and 63b. To the other end of the reaction path 64, there are connected two ejection paths 65a and 65b which are branched from the reaction path 64 and are combined to be in a V-shape.

Cover 67 is jointed on the surface where the microscopic channel 62 is formed on the microscopic-channel substrate 61, through thermal adhesion or through adhesive agents. At positions on the cover 67 which correspond to end portions of respective introduction paths 63a and 63b, inlets 68a and 68b are formed respectively. At positions on cover 67 corresponding to end portions of election paths 65a and 65b, outlets 69a and 69b are formed respectively.

As a material for microchip 70, there are used resins which are excellent in tropical heat stability, chemical resistance, low fluorescence character and in moldability, such as thermoplastic resins like polyethylene, polypropylene and polypentene or saturated cyclic polyolefin.

FIG. 12 is an enlarged diagram for principal parts of the microscopic channel 62 shown in FIG. 11.

As is shown in FIG. 12, there is formed, in the vicinity of the jointing point on the upstream side on the bottom surface of the reaction path 64, projecting-and-depressed section 66 composed of at least two depressed portions which are formed to be arranged in a row in the width direction of the reaction path 64. A height of the projecting-and-depressed section 66 is within a range from 0.01-10 μm.

FIG. 13(a) is a cross-sectional view of the projecting-and-depressed section 66 that is taken on line I-I in FIG. 12.

As is shown in FIG. 13(a), the projecting-and-depressed section 66 has a shape such that projecting-and-depressed portions each having a square cross section are continuously arranged. It is preferable that the height of the projecting-and-depressed section 66 (X2 in FIG. 13(a)) is 5% or less of the depth of the microscopic channel 62, and is specifically preferable that the height is within a range from 0.01 μm to 10 μm.

Further, this projecting-and-depressed section 66 is formed on at least a part of reaction path 64, and a position for forming the projecting-and-depressed section 66 and its length can be established properly, depending on a type and the intended use of the liquid sample.

The projecting-and-depressed section 66 may either be formed in a shape such that projecting portions each having a triangular cross section are arranged at the predetermined intervals or in a shape that projecting-and-depressed portions each having a triangular cross section are continuously arranged as shown in FIG. 13(c). In these cases, it is also possible to adjust an angle of each side wall of the triangular shape of the projecting-and-depressed section 66 to the bottom surface.

Further, the projecting-and-depressed section 66 may be formed in a shape such that depressed portions each having a semicircular cross section are continuously arranged.

After two different types of liquid samples are injected from respective inlets 68a and 68b of cover 67, the two types of liquid samples flow into reaction path 64 through introduction paths 63a and 63b. Then, the two types of liquid samples thus have flowed into the reaction path 64 flows with becoming a laminar flow at projecting-and-depressed section 66 of reaction path 64.

In other words, the projecting-and-depressed section 66 composed of a plurality of grooves arranged in a row in the width direction of microscopic channel 62, is formed on the bottom surface of the microscopic channel 62. Therefore, occurrence of a turbulence flow that interrupts a mainstream of the fluid generated on the bottom surface of the microscopic channel 62 when the two types of liquid samples are mixed, is restrained, and a flow of liquid samples becomes a laminar flow. As a result, the microscopic channel 62 restrains mixture of two types of liquid samples in the projecting-and-depressed section 66. Thus, the mixture is started and reaction occurs from the position where the projecting-and-depressed section 66 of the reaction path 64 does not exist.

After that, liquid samples which have finished reactions are ejected out of outlets 69a and 69b through ejection paths 65a and 65b.

Incidentally, as liquid samples to be applied to microchip 70, an organism sample like blood and organic compounds such as a reagent are used favorably.

In addition, the smaller groove width of microchip 70 can exhibits the more improved mixture efficiency and the smaller groove width enlarges the risk for microscopic channel 2 to be closed. Therefore, the channel width 62 and the groove depth of the microscopic channel need to be established properly depending on a type of reaction and on the intended use.

The microchip 70 shown in FIG. 11 is manufactured in a way that molding die 51 (see FIG. 7 and FIG. 8) is made from electroforming master 91 shown in FIG. 14, and then, resin is formed by the molding die 51 to manufacture microscopic-channel substrate 61 including a surface on which microscopic channel 62 is formed, and the microscopic channel substrate 61 and cover 67 are glued together.

Respective processes in a manufacturing method of microchip 70 shown in FIG. 11 are the same as contents shown in FIG. 7. When microchip 70 shown in FIG. 11 is made by a manufacturing method shown in FIG. 7, projecting-and-depressed section 6 in FIG. 7 corresponds projecting-and-depressed section 66 of the microchip 70.

Next, electroforming master 91 shown in FIG. 14 will be explained in detail.

On a surface of the electroforming master 91, there are formed extremely-microscopic channel-forming grooves 92 formed through cutting processing. The channel-forming grooves 92 preferably have a width and a depth of values within a range of 1 μm-1000 μm, and more preferably has values within the range of 10 μm-1000 μm.

The channel-forming grooves 92 is composed of grooves for introduction path 93a and 93b, groove for reaction path 94 and of grooves for ejection path 95a and 95b, and they correspond respectively to introduction paths 63a and 63b, reaction path 64 and ejection paths 65a and 65b of microchip 70 shown in FIG. 11.

On at least a part of the groove for reaction path 94, there is formed a projecting-and-depressed section (master projecting-and-depressed section) whose shape is the same as that shown in FIGS. 13(a)-13(d) through cutting processing. The height of the projecting-and-depressed section (master projecting-and-depressed section) is within a range of 0.01-10 μm.

Microchip 70 shown in FIG. 11 can restrain the occurrence of a turbulence flow that interrupts a mainstream of the fluid to be a laminar flow, thereby, the microchip 70 can easily control the flow to have the prescribed flow velocity, and to cause the objective reaction efficiently, in the reaction process in which a plurality of liquid samples pass through the microchip 70.

Further, in projecting-and-depressed section 66 of microchip 70, plural liquid samples are made to be a laminar flow, and mixture of plural liquid samples is started from the point where projecting-and-depressed section 66 is not formed. Thus, it becomes possible to control reaction time, and to make a particle size of generated compound to be in a desired size.

In the meantime, with respect to a shape of microscopic channel 62, it is not limited to the present embodiments, and there can be provided a microscopic channel such that plural reaction paths are formed and different projecting-and-depressed sections 66 are formed on bottom surfaces, or that is equipped with three or more grooves for introduction paths which introduce liquid samples of three or more types.

Further, reaction path 64 has only to have a length of path needed for sufficient reaction and mixture for two liquid samples, and its shape may be of a meandering structure or a spiral structure, taking staying time of liquid samples into consideration.

Incidentally, the disclosed embodiment can naturally be varied by those having ordinary skill in the art without departing from the spirit and scope of the invention.

1. A microchip comprising:
a surface on which a channel groove with a width and depth both in a range of 1 to 1000 μm is formed,
wherein a bottom surface of the channel groove comprises a projecting-and-depressed section with a height of 5% or lower of the depth of the channel groove, and
the microchip is formed of a resin material.

2. The microchip of claim 1,
wherein the channel groove comprises a jointing point, and
the projecting-and-depressed section is arranged in a vicinity of the jointing point and at a downstream position of the jointing point, and comprises two or more of depressed portions elongated along a extending direction of the channel groove.

3. The microchip of claim 1,
wherein a height of the projecting-and-depressed section is in a range of 0.01 to 10 μm.

4. A die for forming a microchip, the microchip being formed of a resin material and comprising a surface on which a channel groove with a width and depth both in a range of 1 to 1000 μm is formed,
the die comprising: a projecting potion corresponding to forming the channel groove of the microchip,
wherein a top surface of the projecting portion comprises a die projecting-and-depressed section with a height of 5% or lower of a height of the projecting portion.

5. The die of claim 4,
wherein a height of the die projecting-and-depressed section is in a range of 0.01 to 10 μm.

6. An electroforming master for forming the die of claim 4 through a electroforming, the electroforming master comprising:
a surface comprising a depressed portion corresponding to the projecting portion of the die,
wherein a bottom surface of the depressed portion comprises a master projecting-and-depressed section with a height of 5% or lower of a depth of the depressed portion.

7. The electroforming master of claim 6,
wherein a height of the master projecting-and-depressed section is in a range of 0.01 to 10 μm.
